(19) United States
(12) Patent Application Publication
(10) Pub. No.: US 2005/0102852 A1
(43) Pub. Date: May 19, 2005

(54) Clothes dryer

(76) Inventor: Benny Mizhari, Lowen-Gulile (IL)

Correspondence Address: PAUL H. DEMCHICK;PROFESSOR DEMCHICK'S PATENT SERVICES, THE JACOB TOMLINSON HOUSE, 407 WEST BROAD STREET, WILSON, NC, 27893, US

(21) Appl. No.: 10/893,038

(22) Filed: Jul. 16, 2004

Related U.S. Application Data
(63) Continuation-in-part of application No. PCT/IL02/00145, filed on Feb. 26, 2002.

(51) Int. Cl. F26B 11/02; F26B 5/08

(52) U.S. Cl. 34/130; 34/320

(57) ABSTRACT

An improved clothes dryer. The invention is a clothes dryer, which is capable of effectively drying clothes without heating the air used to dry the clothes. The dryer comprises a clothes container, a means to rotate said clothes container, and a system capable of blowing air with more than 75 times the idealized internal volume of the clothes container per minute through said clothes container. The invention can facilitate significant energy savings, is inexpensive to manufacture and has safety advantages. This is accomplished in this invention by using far more air flow through the dryer than flows through a conventional clothes dryer. The preferred embodiment has a clothes container with a high openness factor. In the preferred embodiment, the fan unit can be readily removed for servicing and cleaning. In the preferred embodiment the fan is capable of blowing approximately 200 times the volume of air as the volume of the clothes container each minute. The preferred embodiment consumes only approximately 500 watts.

### CROSS-REFERENCE TO RELATED APPLICATIONS

This application is a continuation-in-part of, and claims benefit under 35 USC §120 of copending PCT International Application Serial No. PCT/IL02/00145, in which the United States is designated, filed Feb. 26, 2002 (in English), which is hereby incorporated by reference in its entirety.

### STATEMENT REGARDING FEDERALLY SPONSORED RESEARCH OR DEVELOPMENT REFERENCE TO SEQUENCE LISTING, A TABLE, OR A COMPUTER PROGRAM LISTING COMPACT DISK APPENDIX

Not applicable

### BACKGROUND OF THE INVENTION

Clothes were traditionally dried by hanging the clothes or spreading the clothes flat and allowing evaporation to occur. This traditional approach is still used by many people. Although the traditional approach can work well, there- are drawbacks. The traditional approach does not work well in all conditions of temperature, humidity and wind speed. The traditional approach is less well suited to settings with high population densities. Depending on factors including the materials from which the clothes were made, minerals dissolved in local water and how much breeze is present during drying, the traditional approach often causes clothes to dry so that the clothes are stiff or wrinkled. Some people, correctly or incorrectly, associate traditional clothes drying methods with poverty. This perception, and the desire by many people to avoid appearing poor, discourages some people from employing traditional clothes drying methods. It is in large measure, because of the perception that traditional clothes drying is indicative of poverty, that some communities, by ordinance or by private land use restrictions, forbid (or otherwise restrict) outdoor drying of clothes.

Many people use equipment to dry clothes indoors. The “clothes dryers” overcome many of the problems described above. However, clothes dryers consume much energy. In many homes equipped with various appliances, the clothes dryer's energy consumption is second among the appliances only to the refrigerator.

In a typical household clothes dryer, the clothes being dried are in a clothes container commonly called the “drum” or “tumbler.” Typically, these clothes containers approximate right circular cylinders with nearly flat walls at the ends. Often there are baffles which protrude from the inner circumference of the clothes container. One of the nearly flat walls typically includes a door which can be opened to facilitate placing clothes in the clothes container and removing clothes from the clothes container.

Typically, while drying occurs, the clothes are agitated in a way commonly (and aptly) referred to as “tumbling.” The rotation causes the clothes to be lifted by the combination of the clinging of the clothes to the circumference of the clothes container (aided somewhat by centrifugal clinging) and the action of the baffles. However, the rotation is slow enough that the centripetal force is less than the weight of the clothes. Therefore, the clothes falls due to their own weight from near the top of the clothes container. This tumbling facilitates air circulation with the clothes and frequently changes the shape assumed by each garment which helps prevent wrinkling.

In the typical household clothes dryer, fresh air from outside of the dryer replaces the humid air inside the dryer. In most cases, the air taken into the clothes dryer is heated in a controlled manner. The heat facilitates effective evaporation of the water from the clothes. The evaporation is also facilitated by the replacement of the humidity-laden air resulting from the evaporation of the water from the clothes. Electric heating and gas heating are each frequently used to heat the air entering the dryer.

For conventional home clothes dryers, typically, air is drawn into the dryer, drawn through a heater, drawn into the clothes container, drawn through a lint screen, drawn through a fan and is blown out of the dryer. The pressure difference caused by the fan drives this flow. The exact pattern of air flow including the configuration of duct work and the placement of vents is quite variable. The flow through the clothes container is usually facilitated by small holes (typically approximately 0.7 cm) in either the curved surface of the clothes container or in the essentially flat end walls of the clothes container.

The “idealized interior surface area” of an object is taken in this disclosure to be the interior surface area that an imaginary object would have if that imaginary object had the same over-all shape as the actual object but was an entirely closed object lacking in local texture. By way of illustration, in the case of an essentially right circular cylindrical clothes container, the interior surface area would be 2(πr²)+2πrh where “r” is the radius of the cylinder and “h” is the height of the cylinder. This idealized interior surface area would not be influenced by holes in the surface of the actual object, even though the actual surface area would be influenced by that. Likewise, this idealized interior surface area would not be influenced by the surface texture of the actual object, even though the actual surface area would be influenced by that.

Similarly, the “idealized interior volume” of an object is taken in this disclosure to be the volume that an imaginary object would have if it had the same over-all shape as the actual object but was an entirely closed object. By way of illustration, in the case of an essentially right circular cylindrical clothes container, the idealize interior volume would be (πr²)h where r is the radius of the cylinder and h is the height of the cylinder. This idealized interior volume would not be influenced by holes in the surface of the actual object.

The term “openness factor” has been used by others to refer, conceptually, to the portion of the surface of a materials which is open (e.g. holes). However, the precise meaning is often unclear depending on the exact nature of the material. “Openness factor,” as used in this disclosure, is taken to be the total of the area of holes through the wall of the object divided by the idealized interior surface area. For these purposes, the narrowest cross-sectional area of each hole is used in the calculation.

Typically, the same electric motor powers the rotation of the clothes container and the fan. The rotation of the motor and the rotation of the clothes container are typically linked by a belt that goes around the entire clothes container and about a pulley on the motor shaft. The belt also typically goes around a tensioning pulley. Typically, the speed of the fan and the speed of the clothes container are linked by the specific design of the dryer and are not user controllable.

Although typically the same electric motor powers the rotation of the clothes container and the fan, the use of separate motors to power the fan and to rotate the clothes container is not entirely unknown. In U.S. Pat. No. 6,088,932, Adamski teaches the use of separate fan and clothes container motors in some embodiments of the invention which is the subject of that disclosure. However, that disclosure does not teach the use of a user adjustable fan speed.

Typically, the user of a home clothes dryer can set the temperature to which the air entering the dryer is to be heated. Typical setting options range from approximately 35° C. to approximately 90° C. Typically, the user can select to not have the air heated. However, that typically accomplishes drying very slowly and is used frequently to “fluff” clothes rather than to dry clothes.

The air flow in a typical conventional clothes dryer is approximately 175 cubic feet per minute. The idealized interior volume in a typical conventional clothes dryer is approximately 7 cubic feet. The openness factors of conventional clothes dryers vary considerably. However, an openness factor in the range of 1% is not atypical.

Typically, the heating of the air entering the clothes dryer involves far greater energy consumption than the mechanical rotation of the clothes container and operation of the fan. The other energy consumptions related to a clothes dryer, such as operation of controls, are usually quite minor components.

In U.S. Pat. No. 2,707,338, Morrison disclosed a clothes dryer that did not heat the air. The disclosed design includes a stationary shield which directs air in a manner which prevents it from bypassing the clothes container or passing through the perforated clothes container where there are no clothes.

In U.S. Pat. No. 3,3608,871, Wattenford discloses a clothes dryer with no air heating means. However, the invention disclosed in that patent is intended to use heat provided externally by an oil stove over which the disclosed clothes dryer is placed.

Conventional clothes dryers can be fire hazards. Approximately 14,600 residential structural fires were caused by clothes dryers in the United States in 1999. These resulted in 300 injuries and over $86 million dollars in property losses (“1999 Residential Fire Loss Estimates” U.S. Consumer Product Safety Commission, Released 2003).

Gas heated conventional clothes dryers can be carbon monoxide hazards (“Non-Fire Carbon Monoxide Deaths and Injuries Associated with the Use of Consumer Products Annual Estimates” U.S. Consumer Product Safety Commission, 2002).

Energy efficiency improvements of conventional clothes dryers have been driven by economics and the regulations of various governments. Much of that improvement has been based of better control of the process. For example, moisture sensing can facilitate more appropriate timing of when to stop the drying. However, greater energy efficiency is still desired.

### BRIEF SUMMARY OF THE INVENTION

The invention disclosed here is a clothes dryer specifically designed to operate with air which is not heated. The invention is inexpensive to manufacture and can facilitate significant energy savings. This is accomplished in this invention by using far more air flow through the clothes dryer than flows through a conventional clothes dryer.

### BRIEF DESCRIPTION OF THE SEVERAL VIEWS OF THE DRAWING

FIG. 1 is a perspective representation of the preferred embodiment of the invention. It is drawn as viewed from above and to the side of the front of the cabinet (from essentially the same point of view as FIG. 2, FIG. 5, FIG. 7 and FIG. 11). It shows selected exterior features of the preferred embodiment of the invention disclosed here.

FIG. 2 is a cut-away perspective representation showing selected features of the preferred embodiment of the invention. It is partially see-through to allow features behind the back wall of the clothes container to be shown. It was drawn as though the front of the cabinet was removed. It is drawn as viewed from above and to the side of the front of the cabinet (from essentially the same point of view as FIG. 1, FIG. 5, FIG. 7 and FIG. 11). It shows selected exterior and interior features of the preferred embodiment of the invention disclosed here.

FIG. 3 is a cut-away perspective representation showing selected features of the preferred embodiment of the invention. It was drawn as though the front of the cabinet was removed. It is drawn as viewed from straight in front of the cabinet. It shows, in context, selected features responsible for the support of the clothes container in the preferred embodiment of the invention disclosed here.

FIG. 4 is a cut-away perspective representation showing selected features of the preferred embodiment of the invention. It was drawn as though the rear of the cabinet was removed. It is drawn as viewed from straight in back of the cabinet. It shows the system that causes the rotation of the clothes container in the preferred embodiment of the invention disclosed here.

FIG. 5 is a see-through perspective representation showing, in context, the flow of air into and out of the preferred embodiment of the invention disclosed here. It is drawn as viewed from above and to the side of the front of the cabinet (from essentially the same point of view as FIG. 1, FIG. 2, FIG. 7 and FIG. 11).

FIG. 6 is a cut-away representation showing, in context, selected aspects related to the fan assembly of the preferred embodiment of the invention. It was drawn as though the front of the cabinet was removed. It is a non-perspective view from the front of the cabinet.

FIG. 7 is a perspective representation of the preferred embodiment of the invention. It is drawn as viewed from above and to the side of the front of the cabinet (from essentially the same point of view as FIG. 1, FIG. 2, FIG. 5 and FIG. 11). It shows selected exterior features of an alternative embodiment of the invention disclosed here. For clarity, those features shown essentially identically to those shown in FIG. 1 which are labeled on FIG. 1 are not labeled on this Figure, but should be understood to be the same.

FIG. 8 represents a small piece of the clothes container of the preferred embodiment of the invention disclosed here shown approximately to scale. The black represents the stainless steel rods. The purpose of FIG. 8 is to give a sense of the openness of the clothes container.

FIG. 9 represents in simplified schematic form the air flow into and out of the clothes container in the preferred embodiment of the invention disclosed here and selected prior art clothes dryers. The arrows represent air flow. The arrows with filled heads represent air leaving a clothes container. The arrows with non-filled heads represent air entering the clothes container. Three different arrangements are shown. Each clothes container is essentially a right circular cylinder. View “A” represents a conventional clothes dryer. Views “B” and “C” represent the invention disclosed by Morrison in U.S. Pat. No. 2,707,338. Views “D” and “E” represent the preferred embodiment of the invention disclosed here. Views “A,” “B” and “D” are viewed from a vantage that allows a broad view of one side of the curved part of the clothes container, and allows only a slight view of the front of the clothes container. Views “C” and “E” are approximately orthogonal to view “B” and “D” respectively. Views “C” and “E” are viewed from a vantage that allows a broad view of the front of the clothes container and allows only a slight view of one side of the curved part of the clothes container. The dotted lines in “B” and “C” represent the air blocking shield and “partition wall” of the Morrison disclosure.

FIG. 10 includes three depictions of the fan unit of the preferred embodiment of the invention disclosed here. View “a” is an exterior view of the fan unit with the vent hatch closed. View “b” is an exterior view of the fan unit with the vent hatch open. View “c” shows selected internal details of the fan unit.

FIG. 11 is a perspective representation of the preferred embodiment of the invention. It is drawn as viewed from above and to the side of the front of the cabinet (from essentially the same point of view as FIG. 1, FIG. 2, FIG. 5 and FIG. 7). It shows the relationship between the fan unit and the dryer as a whole.

### DETAILED DESCRIPTION OF THE INVENTION

One object of the invention disclosed here is to improve the energy efficiency of the clothes drying process. This is accomplished, in brief, by not requiring the heating of air done by conventional clothes dryers.

Another object of the invention disclosed here is to allow less expensive manufacturing than is required for conventional clothes dryers. The reduced cost is principally due to the lack of an air heating means and the fact that heat resistant materials do not need to be employed.

Yet another object of the invention disclosed here is to reduce the fire and carbon monoxide hazards present in conventional clothes dryers.

The above stated objectives are accomplished in this invention by using far more air flow through the clothes dryer than flows through a conventional clothes dryer.

The preferred embodiment has a cabinet which is essentially a cube which is approximately 70 cm in each height, width and length. There is little air flow in or out of the cabinet other than through the vents described later. Inside that cabinet, an essentially cylindrical clothes container is mounted so that the clothes container can rotate about the cylinder axis.

The clothes container of this preferred embodiment is made of stainless steel rods which are each approximately 3 mm in diameter. The spacing of the rods is approximately 4 cm on center. This gives the clothes container an openness factor of approximately 85%. The design of the clothes container affords far more openness than the typical conventional clothes dryer. In fact, “basket” or “cage” would be a better term for the clothes container of the preferred embodiment than “drum.” That openness is conducive to far greater air flow in the invention disclosed here than the air flow in the typical conventional clothes dryer. It is important to note that the clothes container could take various specific forms in terms of materials and shapes in other embodiments of the invention.

In the preferred embodiment of the invention disclosed here, the clothes container is almost as large as can be accommodated in the cabinet. The clothes container has no baffles. A centrifugal fan is mounted along one side of the cabinet, near the bottom, in the space between the clothes container and the cabinet wall and immediately above the cabinet floor. The fan blows air into the clothes container across most of the depth of the clothes dryer. This fan speed can be adjusted by the user to blow approximately 900, 1100 or 1300 cubic feet per minute. The fan speed adjustment can be done by using a switch.

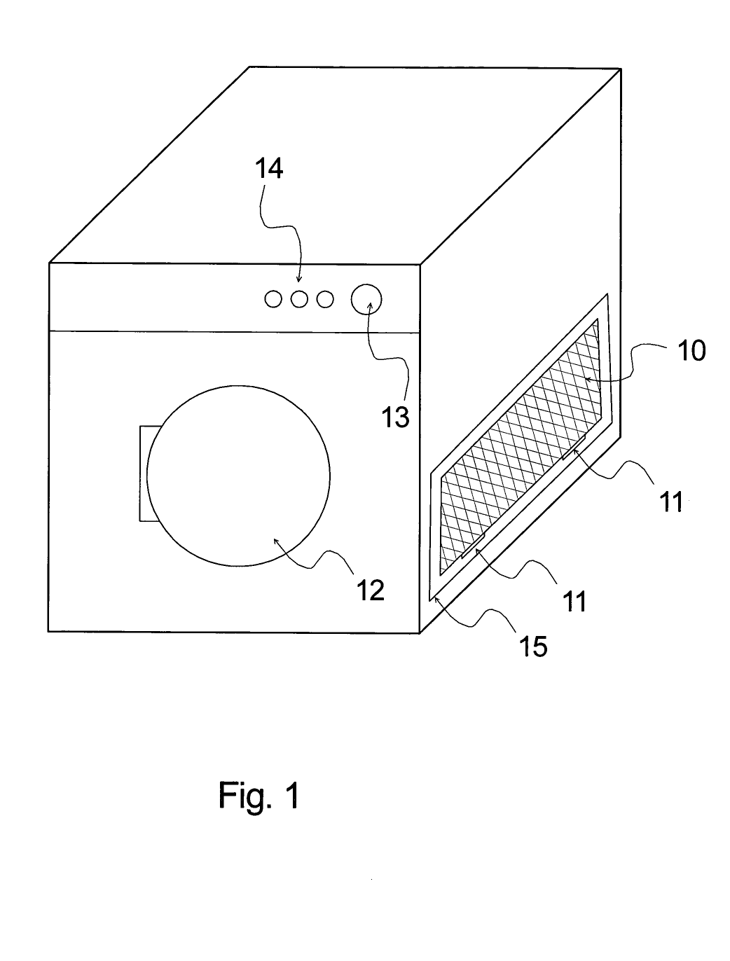

Referring to FIG. 1, in the preferred embodiment of this invention, air is drawn in through a vent 10. The vent 10 is attached to the rest of the fan unit by hinges 11. The vent can be opened without the use of any tools. On the inside of the grill of the vent, an air filter is disposed to filter the incoming air. The clothes are placed in the clothes dryer and removed from the clothes dryer using a hinged door 12 on the front of the cabinet. A switch prevents, during times the door is ajar, powering of the fan motor or powering of the motor that causes the clothes container to rotate. (Conventional clothes dryers typically have a similar stop-when-ajar feature.) The clothes dryer is controlled by a user controlled timer 13 disposed on the front of the cabinet. The control 14 to allow the user to set the fan speed is also disposed on the front of the cabinet. The boundary 15 between the external face of the fan unit (discussed later in this disclosure) and the rest of the cabinet is shown.

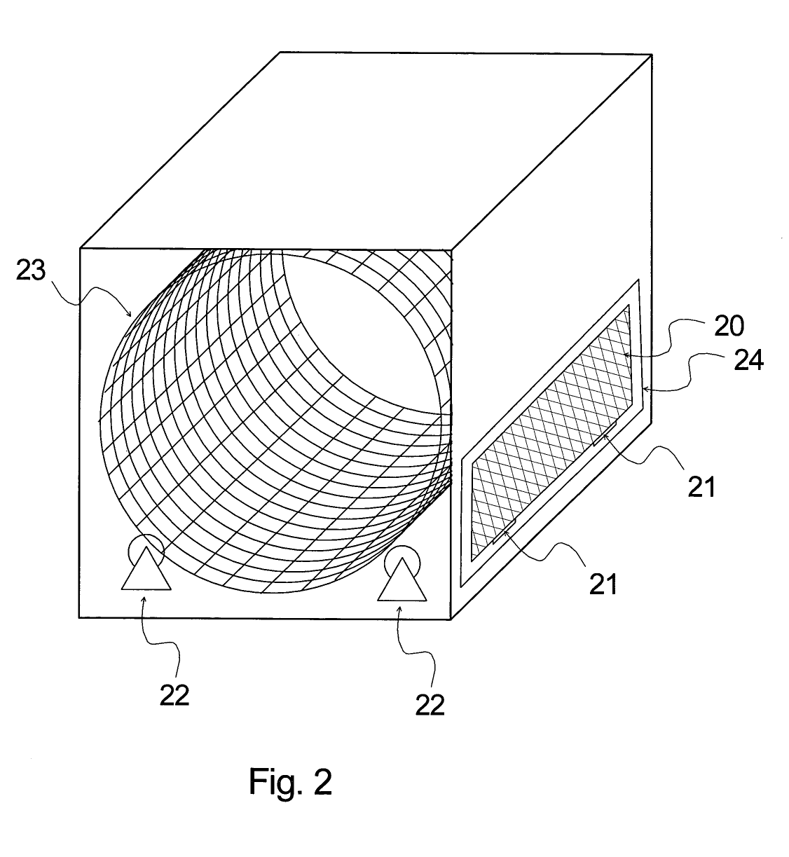

Referring to FIG. 2, which is another representation of the preferred embodiment of the invention disclosed here, the vent 20 and hinges 21 are again shown. In this view, certain internal features are represented. The clothes container 23 is represented. Near the front of the cabinet, two rollers 22 support the clothes container near the front. Those rollers 22 passively facilitate the rotation of the clothes container 23. The boundary 24 between the external face of the fan unit and the rest of the cabinet is shown.

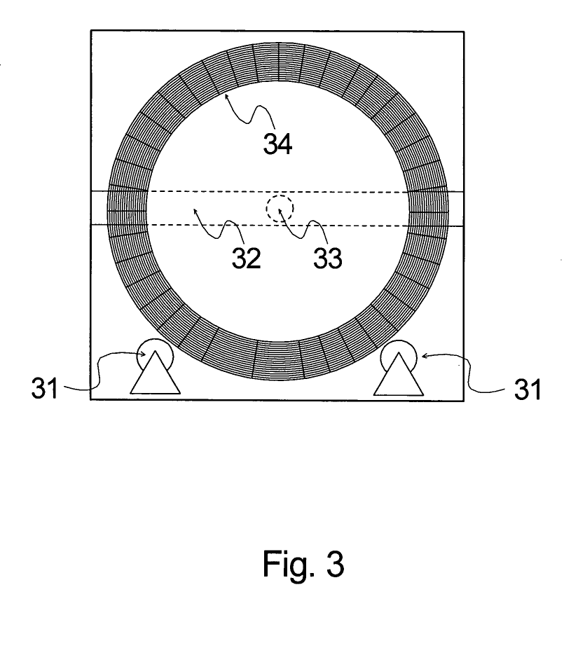

Referring to FIG. 3, the rollers 31 are again shown supporting the clothes container 34 near the front in the preferred embodiment. Mounted to the back wall of the cabinet is a brace 32 (shown as partially “hidden” in drawing) to which a bearing 33 (shown as “hidden” in drawing) is attached. That bearing 33 connects to the rear wall of the clothes container 34, supporting the clothes container in the back.

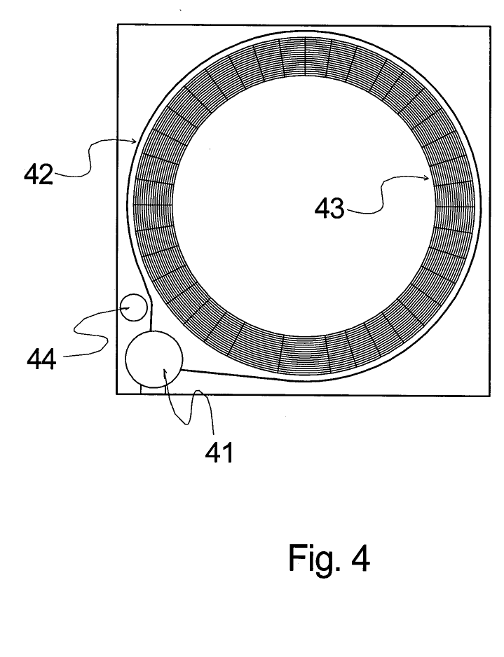

Referring to FIG. 4, the clothes container 43 of the preferred embodiment is rotated by similar means to a conventional clothes dryer. An electric motor 41 is mounted on the base of the cabinet toward the back, toward one side of the cabinet. A belt 42, goes around the shaft of the electric motor 41 and around the clothes container 43. The belt is tensioned by a tensioning pulley 44 which deflects the path of the belt 42. For clarity, the details of the tensioning mechanism are not shown. However, the mechanism is similar to that found typically on a conventional clothes dryer. Unlike in a conventional clothes dryer, the motor 41 in the preferred embodiment of the invention disclosed here is responsible only for the rotation of the clothes container, not for the driving of the fan. This allows the fan speed to be adjusted without the speed of rotation of the clothes container changing. The rate of rotation of the clothes container allows the clothes to “tumble” in a manner similar to a conventional clothes dryer.

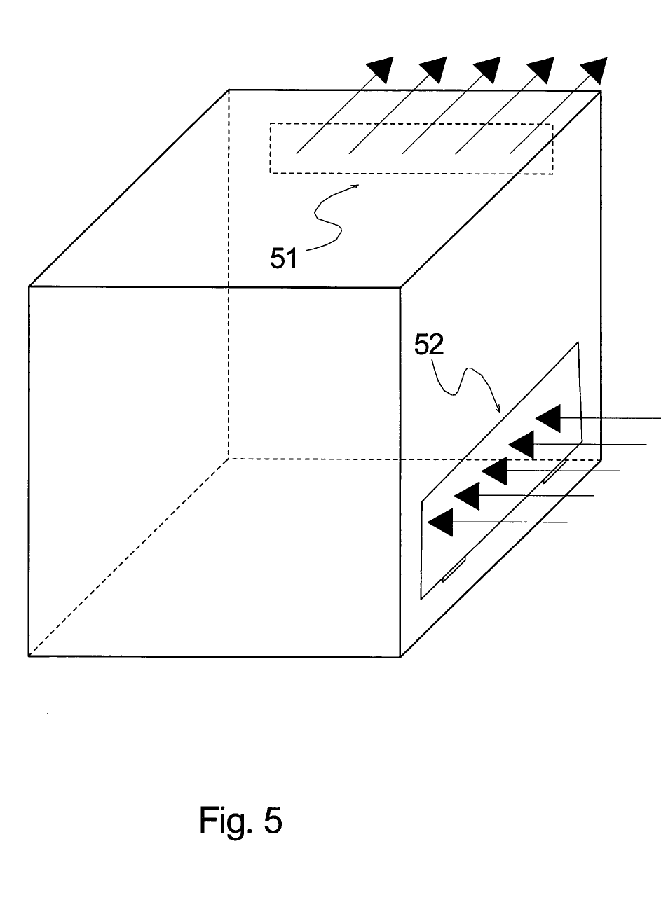

Referring to FIG. 5, the cabinet of the preferred embodiment is represented in see-through form without showing the internal structures. It shows where air enters 52 and where air exits 51 the clothes dryer in the preferred embodiment when the clothes dryer is in use. The exhaust vent would be placed at a window to allow the moist air to leave. A more detailed air path (including structures not shown in FIG. 5) is that the air enters through the in-vent grill 52, passes through the filter, passes through the fan, passes into the clothes container, passes into the cabinet around the clothes container, and leaves through the out-vent 51.

In cases of indoor use, the air that leaves the out-vent could be vented through a window or dedicated vent. That dedicated vent would be similar to those typically used in connection with conventional clothes dryers, except that a wider vent would be optimal to accommodate the greater air flow. An alternative embodiment of the invention disclosed here would have fittings to accommodate installation that included dedicated venting of exhaust air. It should be noted that the vent through which the exhaust air leaves the clothes dryer could be located almost anywhere on the cabinet of the clothes dryer.

It would be possible to equip the clothes dryer with a lint filter. However, experience with the preferred embodiment of the invention does not indicate a practical need for that. Although no measurements have been made, informal observation of the operation of the clothes dryer disclosed here suggests that it liberates far less lint than a conventional clothes dryer.

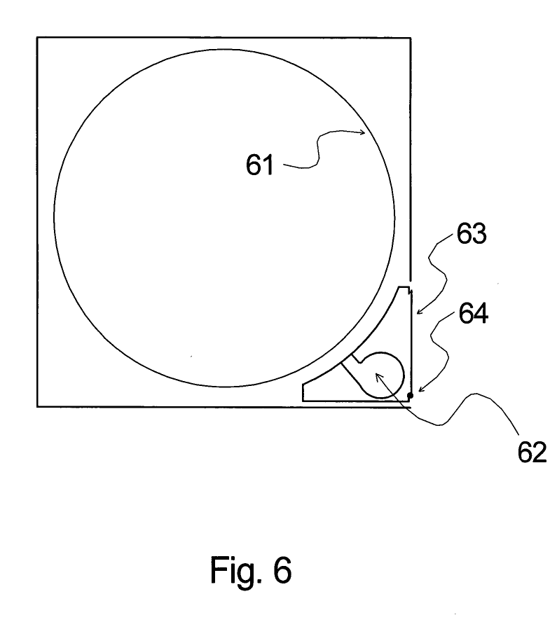

Referring to FIG. 6, which shows certain features of the preferred embodiment of the disclosed invention, the centrifugal fan 62 draws air through the vent hatch 63 and blows the air into the clothes container 61 which contains the clothes. The hinges 64 attach the vent hatch 63 to the rest of the fan unit. By opening the vent hatch 63, the air filter can be replaced. A dedicated electric motor turns the fan. The span of the air blowing portion of the fan is almost the entire depth of the clothes container. The fan unit can be removed for servicing of the components housed in that unit (discussed in more detail later in this disclosure).

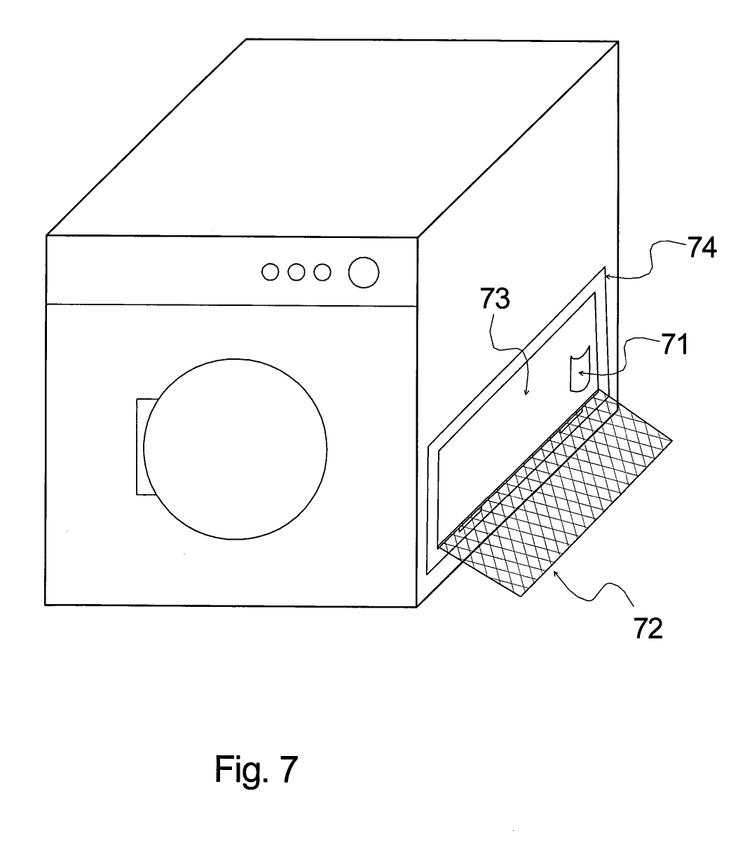

FIG. 7 represents an alternative embodiment of this invention. The boundary 74 between the external face of the fan unit and the rest of the cabinet is shown. The clothes dryer is shown with the vent hatch 72 open. In this alternative embodiment, a small open-topped container 71 is mounted on the face of the fan unit 73 which is next to the vent hatch when the clothes dryer is in use. A volatile liquid can be placed in the container. The liquid can evaporate and impart a desired scent to the clothes.

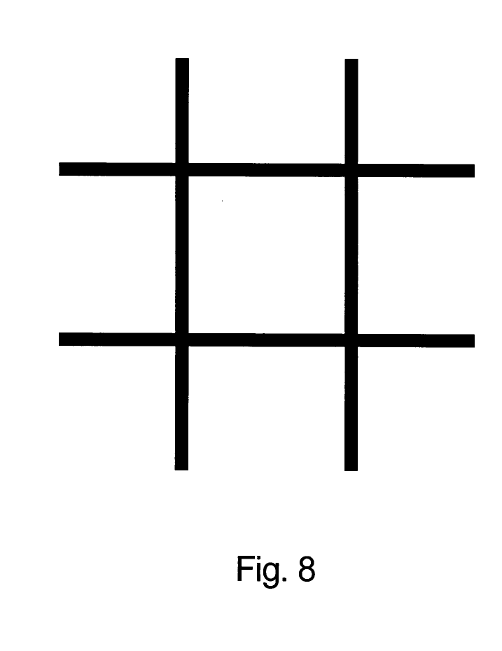

FIG. 8 represents a small piece of the clothes container of the preferred embodiment of the invention disclosed here shown approximately to scale. In that figure, the black represents the stainless steel rods. This figure shows the high degree of openness of the clothes container.

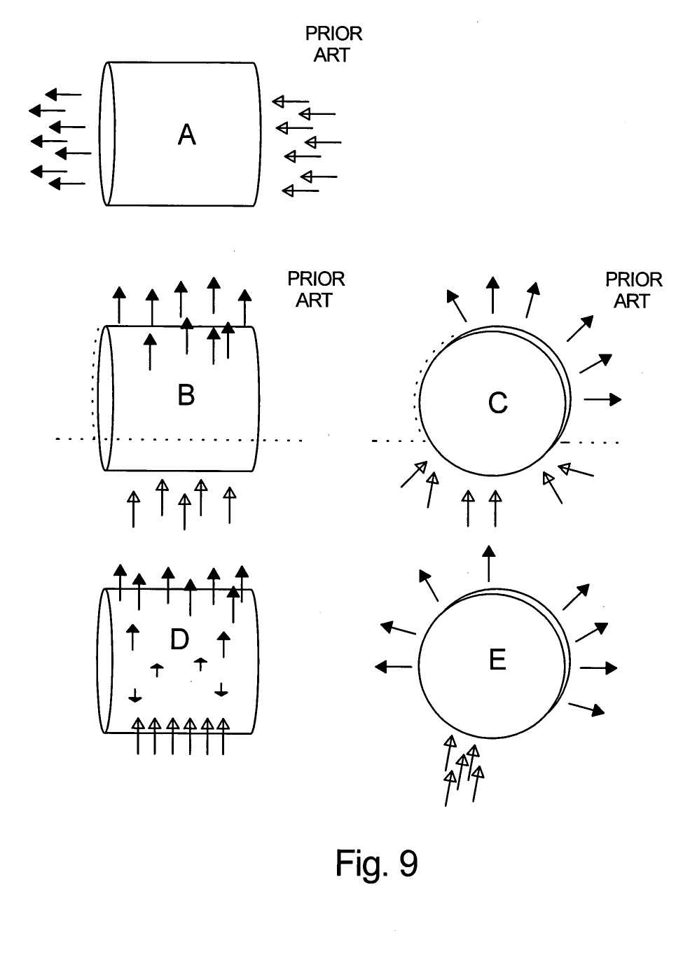

FIG. 9 represents, in simplified schematic form, the air flow into and out of the clothes container in the preferred embodiment of the invention disclosed here and in selected prior art clothes dryers. The arrows represent air flow. The arrows with filled heads represent air leaving a clothes container. The arrows with non-filled heads represent air entering the clothes container. Three different clothes dryer types are shown. The clothes container of each clothes dryer is essentially a right circular cylinder. View “A” represents a conventional clothes dryer. Views “B” and “C” represent the invention disclosed by Morrison in U.S. Pat. No. 2,707,338. Views “D” and “E” represent the preferred embodiment of the invention disclosed here. Views “A,” “B” and “D” are viewed from a vantage that allows a broad view of one side of the curved part of the clothes container and allows only a slight view of the front of the clothes container. Views “C” and “E” are approximately orthogonal to view “B” and “D” respectively. Views “C” and “E” are viewed from a vantage that allows a broad view of the front of the clothes container and allows only a slight view of one side of the curved part of the clothes container. The dotted lines in “B” and “C” represent the air blocking shield and “partition wall” of the Morrison disclosure. The air flow pattern of the invention disclosed here is different from the other clothes dryers shown.

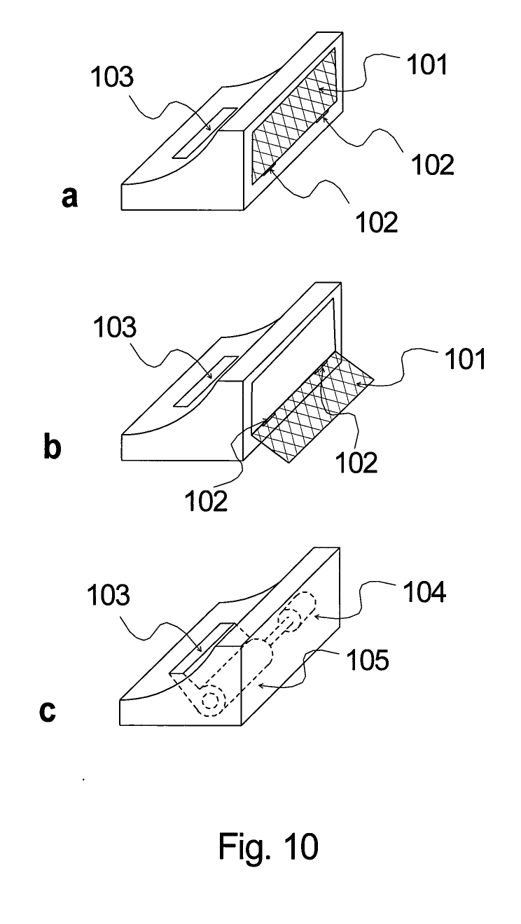

Referring to FIG. 10, which includes three depictions of the fan unit of the preferred embodiment, the vent hatch 101 is shown closed (in “a”) and open (in “b”). There is a hinged connection 102 between the vent hatch and the casing of the fan unit. View “c” depicts selected internal details of the fan unit. For clarity, view “c” does not show the vent hatch. When in operation, a dedicated motor 104 causes the rotation of the fan 105. When in operation, air is blown by the fan 105 through an opening 103 in the case of the fan unit.

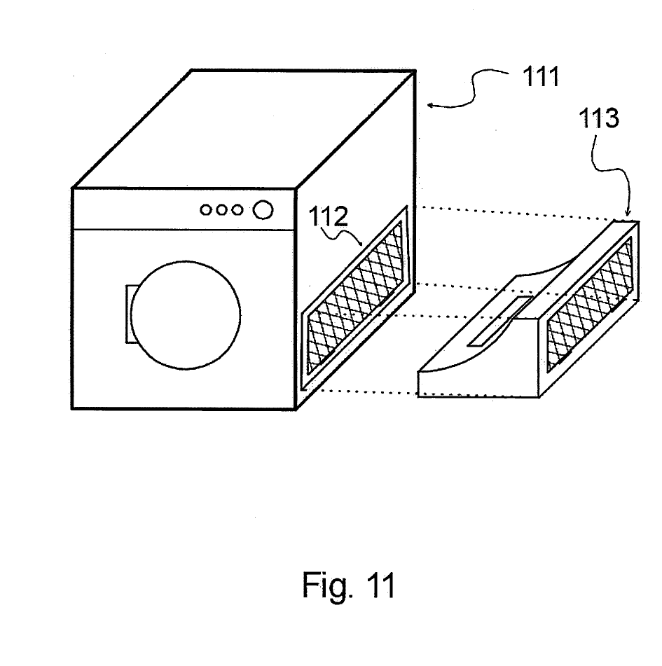

FIG. 11 is a perspective representation of the preferred embodiment of the invention. It is drawn as viewed from above and to the side of the front of the cabinet (from essentially the same point of view as FIG. 1, FIG. 2, FIG. 5 and FIG. 7). It shows the relationship between the fan unit (112, 113) and the clothes dryer 111 as a whole. When the fan unit 112 is installed in the cabinet of the clothes dryer 111, only the face housing the vent hatch is on the exterior of the clothes dryer. The fan unit is also shown removed from the rest of the clothes dryer as 113.

In an alternative embodiment, the clothes container has a net-like lining to retain smaller objects than can be retained by the metal clothes container described as the preferred embodiment. However, such a net-like lining does little to retard the air flow so important in this design.

In an alternative embodiment, the outer wall of the cabinet is open to air passage. This embodiment could be appropriate in outdoor settings such as a balcony of an apartment.

In an alternative embodiment, another type of closure (such as a screw-on lid) replaces the hinged door of the preferred embodiment.

In an alternative embodiment, there is no removable fan unit. In this alternative embodiment, the fan and the motor for the fan are mounted in the cabinet in a manner that is not conducive to easy, tool-free removal.

In an alternative embodiment, the clothes dryer is controlled by moisture sensing means instead of (or in addition to) a timer.

In an alternative embodiment, the clothes container can be equipped with baffles which would function similarly to the function of baffles in a clothes container of a conventional clothes dryer.

Key to the design of this invention is the large volume of air passing through the clothes dryer. The preferred embodiment of this invention can draw through approximately 200 times the volume of air as the volume of the clothes container. That is approximately eight times as much as in a typical conventional clothes dryer. The incoming air serves two distinct purposes. The air replaces air made more humid by evaporation of moisture on the clothes. It also supplies heat to the cloths which are cooled by evaporative cooling.

The invention disclosed here can operate far more energy efficiently than can a conventional clothes dryer. The preferred embodiment of this invention uses approximately 500 watts. A typical electric conventional clothes dryer with a similar capacity uses approximately 6000 watts.

In addition to the major advantages of lower manufacturing cost and lower energy uses, the invention disclosed here can be gentler to clothes in that the air is cooler than in a conventional clothes dryer.

Yet another advantage is that permanent-press clothes do not require the sort of “cool-down” period common in conventional clothes dryers.

Yet another advantage is that clothes need not be separated for drying on the basis of temperature sensitivity. This can result in a labor savings. It can also facilitate sorting based on other factors such as how thick the fabric is.

From the above description and drawings, it will be understood by those of ordinary skill in the art that the particular embodiments shown and described are for purpose of illustration only and are not intended to limit the scope of the invention. Those of ordinary skill in the art will recognize that the invention may be embodied in other specific forms without departing from its spirit or essential characteristics. References to details of particular embodiments are not intended to limit the scope of the claim.

1. A clothes dryer, which is capable of effectively drying clothes without heating the air used to dry the clothes, comprising a clothes container, a means to rotate said clothes container, and a system capable of blowing air with more than 75 times the idealized internal volume of said clothes container per minute through said clothes container.

2. A clothes dryer as in claim 1 which lacks any means to heat air.

3. A clothes dryer as in claim 1 in which said system is capable of blowing air with more than 75 times the idealized internal volume of said clothes container per minute through said clothes container.

4. A clothes dryer as in claim 2 in which said system is capable of blowing air with more than 75 times the idealized internal volume of said clothes container per minute through said clothes container.

5. A clothes dryer as in claim 1 in which said system is capable of blowing air with more than 100 times the idealized internal volume of said clothes container per minute through said clothes container.

6. A clothes dryer as in claim 2 in which said system is capable of blowing air with more than 100 times the idealized internal volume of said clothes container per minute through said clothes container.

7. A clothes dryer as in claim 1 in which said system is capable of blowing air with more than 150 times the idealized internal volume of said clothes container per minute through said clothes container.

8. A clothes dryer as in claim 2 in which said system is capable of blowing air with more than 150 times the idealized internal volume of said clothes container per minute through said clothes container.

9. A clothes dryer as in claim 1 in which an electric motor is used to power the rotation of the clothes container and a different electric motor is used to power the blowing of the air.

10. A clothes dryer as in claim 1 in which the rate at which the air is blown can be controlled by the user without influencing the rate of rotation of said clothes container.

11. A clothes dryer, which is capable of effectively drying clothes without heating the air used to dry the clothes, comprising a clothes container with an openness factor of no less than 40%, and a means to rotate said clothes container.

12. A clothes dryer as in claim 11, in which the clothes container has an openness factor of no less than 60%.

13. A clothes dryer as in claim 11, in which the clothes container has an openness factor of no less than 80%.

14. A clothes dryer as in claim 5 in which the clothes container has an openness factor of no less than 60%.

15. A clothes dryer as in claim 12 in which the dryer further comprises a filter to remove particles from the air being drawn into the dryer.

16. A clothes dryer as in claim 12 in which the dryer further comprises a container mounted near the air in-vent which, if said container holds a volatile liquid, would allow vapor of that liquid to mix with air flowing into the dryer.

17. A clothes dryer as in claim 5 in which the idealized internal volume of said clothes container is less than 15 cubic feet.

18. A clothes dryer as in claim 5 in which the idealized internal volume of said clothes container is greater than 2 cubic feet.

19. A clothes dryer as in claim 12 in which the cabinet of said clothes dryer is essentially impermeable to air flow except for vents covering less than 20% of the combined surface area of the four sides and the top of the dryer.

20. A clothes dryer as in claim 2 in which air is blown by a fan housed in a unit which can be readily removed from, and reinstalled in, the clothes dryer.
